(19) United States
(12) Patent Application Publication
(10) Pub. No.: US 2026/0184273 A1
(43) Pub. Date: Jul. 2, 2026

(54) Functional Module Onboard a Vehicle

(71) Applicant: Bayerische Motoren Werke Aktiengesellschaft, Muenchen (DE)

(72) Inventors: Christoph GOLLOB, Karlsfeld (DE); Michael KAINDL, Ergoldsbach (DE)

(21) Appl. No.: 18/728,633

(22) PCT Filed: Dec. 15, 2022
(86) PCT No.: PCT/EP2022/086010

§ 371 Date: Jul. 12, 2024

(30) Foreign Application Priority Data
Feb. 16, 2022 (DE) 10 2022 103 670.7

(51) Int. Cl. B60R 16/023; B60R 16/03; G01S 13/931

(52) U.S. Cl. CPC B60R 16/0231; B60R 16/03; G01S 13/931

(57) ABSTRACT

A functional module for a vehicle may comprise a positive and a negative connection for supplying the functional module with an operating voltage and comprising at least two supply connections for connecting to an external voltage. Each supply connection is connected to the positive connection of the functional module by means of a first diode and to the negative connection of the functional unit by means of a second diode, wherein the passage direction of the diodes points from the negative connection to the positive connection in each case. A functional module may additionally comprises two output connections for connecting to supply connections of another functional module, wherein the output connections are connected to the external voltage by means of a voltage reducer. The functional module is designed to determine a voltage drop across the voltage reducer and between which of the supply connections a voltage is being applied.

### BACKGROUND AND SUMMARY

The present disclosure relates to a functional module on board a vehicle. In particular, the present disclosure relates to the individualization of functional modules of identical construction on the vehicle.

A vehicle includes a system with several sensors which have been mounted at different positions on the vehicle. For reasons of cost, it is desirable to design the sensors to be interchangeable. In order that a measurement can be undertaken in a manner depending on the position of the sensor, each sensor is to be capable of determining the position at which it is located.

An address that has been allocated within the system only once can be assigned to each sensor, and a position may have been assigned to each address. Each sensor may possess a number of coding pins which are each connected to a high or a low electrical potential, according to the installation position. A combination of levels that can be determined at the coding pins then indicates the address and consequently the position. However, relatively many coding pins may be required for this technique. If a sensor is located in the exterior domain, all the terminals need to be designed to be dustproof and watertight, so significant costs may arise. In addition, a routing of cables between the sensors may be costly.

One object underlying the present disclosure consists in specifying an improved technique with which a functional module on board a vehicle can be individualized. The present disclosure achieves the object by means of the subject-matters of the independent claims. Dependent claims reproduce preferred embodiments.

According to a first aspect of the present disclosure, a functional module for a vehicle includes a functional unit, with a positive terminal and a negative terminal for supplying the functional unit with an operating voltage, and at least two supply terminals for connecting to an external voltage. Each supply terminal is connected to the positive terminal by means of a first diode, and connected to the negative terminal of the functional unit by means of a second diode. Forward directions of the diodes each point from the negative terminal to the positive terminal. Furthermore, the functional module includes two output terminals for connecting to supply terminals of a further functional module of identical construction, the output terminals being connected to the external voltage by means of a voltage-reducer. The functional unit has been set up to determine a drop in voltage across the voltage-reducer, and to determine the supply terminals between which a voltage is applied.

In accordance with the present disclosure, two approaches are advantageously combined with one another in order to obtain an individualization of the functional module via its connection to the external voltage. The individualization preferably consists in the fact that the functional module is able to collect information that establishes its identity on board the vehicle. Each functional module on board the vehicle is preferably individual. The individualization is undertaken with the aid of a routing of supply current to the functional module, so the number of additional terminals can be small.

According to a first approach, the external voltage can be applied with arbitrary polarity to any two of the supply terminals. By virtue of the diodes, the functional unit is, in any case, supplied at its terminals with the operating voltage in the correct polarity. By virtue of the determination of the supply terminals between which the external voltage is applied, and in which polarity, a first indication of the identity of the functional module can be determined.

According to a second approach, the functional module can relay current to a further functional module. Whether another functional module has been connected downstream of the functional module can be detected, in that a drop in voltage will obtain at the voltage-reducer. Without the drop in voltage, on the other hand, no supply of a downstream load is occurring. In this way, a second indication of the identity of the functional module can be determined.

By virtue of the described combination of the two techniques, the functional module can be easily and reliably supplied with current on board a vehicle and individualized. Cabling of several functional modules on board the vehicle can be simplified.

The functional module can be employed, in particular within the scope of a system, together with one or more further functional modules on board the vehicle. The functional modules may have been constructed identically and can each be individualized by appropriate connections to the external voltage. As a result, the functional modules can be produced cost-effectively as like parts and can be employed on the vehicle.

A coupling of a functional module to the vehicle can be undertaken by means of a multipolar electrical connection, so that the electrical connection defines an identity of the functional module. Several prepared electrical connections may have been attached to a cabling of the vehicle at predetermined positions, so a functional module can be easily and reliably individualized to a position by being connected to the cabling at that position.

The functional unit has preferably been set up to carry out a predetermined task in a manner depending on a combination of supply terminals, between which the external voltage is applied, and a drop in voltage at the voltage-reducer. The specific combination may serve as address or individualization of the functional unit and may have been assigned to a position on the vehicle—for instance, front left, front right, side left, side right, rear left or rear right. In this way, the functional module can perform its task in improved manner, depending on its position.

More preferably, the functional unit includes one of a sensor, an actuator and a processing device for performing the function. The sensor may comprise, for instance, a radar sensor, a lidar sensor or an ultrasonic sensor. The actuator may comprise, for instance, a lighting device or signaling device or a mechanical actuating device. The processing device may be encompassed by a control device on board the vehicle.

In some implementations, the voltage-reducer comprises a diode in the forward direction. If a further functional unit has been connected to the output terminals, a current flows through it during operation and the diode becomes conductive, so a predetermined drop in voltage of approximately 0.3 V to 0.7 V can be determined at its terminals. The drop in voltage is constant and corresponds to a threshold voltage assigned to the type of diode being used. If, on the other hand, no further functional module has been coupled, the diode has a blocking action and the drop in voltage at its terminals does not correspond to the threshold voltage. In other implementations, two antiparallel diodes can be used as voltage-reducer, so that the further functional module can be coupled with differing polarities.

The functional unit may exhibit an analog input which is connected to the output terminal that is connected to the voltage-reducer. If no current is flowing through the diode, there is an unreduced voltage at the terminal. The drop in voltage can be determined with little effort. In this way, the drop in voltage can be determined with little effort.

In a development, the functional unit exhibits a further analog input which is connected to the terminal of the voltage-reducer that is not connected to the output terminal. In this way, the drop in voltage can easily be determined as the difference of the voltages at the two terminals of the diode. This determination can be undertaken particularly precisely or particularly reliably, so a faulty determination can be avoided.

The functional unit may exhibit at least one digital input, in order to determine a level at one of the supply terminals. The digital input may have been realized as a Schmitt trigger, in order to enable a reliable determination of the level. A hysteresis of the Schmitt trigger may be predetermined or capable of being chosen. In another embodiment, an analog input can be used in order to determine the level. It may also be possible to determine that a supply terminal has not been connected to the external voltage at all. For this purpose, the supply terminal can be dragged to a predetermined potential by means of a voltage-divider.

The functional module may include an interface for a communication bus for communicating with an external location. The communication bus preferably connects all the functional modules of a system and may have been connected to yet further components, for instance to a control device of the system. The communication bus may comprise, for instance, a CAN bus or LIN bus or Ethernet.

According to a further aspect of the present disclosure, a system comprises several functional modules described herein, in which case for each functional module in the system a combination of supply terminals, between which an external voltage is applied, and a drop in voltage at the voltage-reducer is unique. The system may further include a current-source, for making the external voltage available, and/or a central location that has been set up to control at least one of the functional modules. The central location has preferably likewise been connected to the communication bus.

According to yet another aspect of the present disclosure, a vehicle includes at least one functional module described herein. More preferably, the vehicle includes a system described herein with several functional modules. Features or advantages of the present disclosure can be carried across between its different described manifestations.

### BRIEF DESCRIPTION OF THE DRAWINGS

The present disclosure will now be described in more detail with reference to the appended drawings, in which:

FIG. 1 illustrates a vehicle with a system;

FIG. 2 illustrates a circuit diagram of a functional module in a first embodiment;

FIG. 3 illustrates a circuit diagram of a functional module in a second embodiment;

FIG. 4 illustrates a circuit diagram of two interconnected functional modules; and

FIG. 5 illustrates a further system in a vehicle.

### DETAILED DESCRIPTION OF THE DRAWINGS

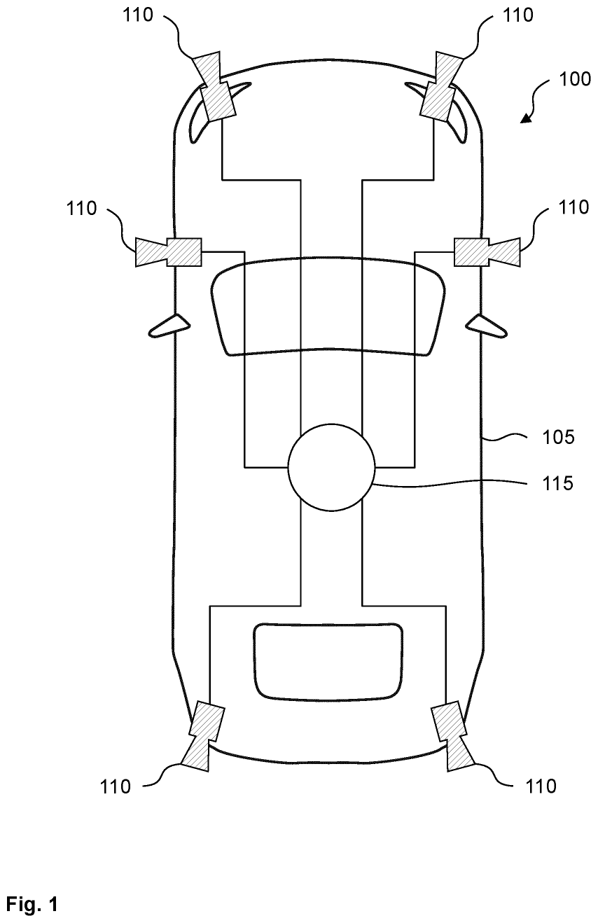

FIG. 1 shows a vehicle 100 with a system 105. The vehicle 100 preferably comprises a motor vehicle, in particular a motorcycle, a passenger car, a truck or a bus. The system 105 comprises several functional modules 110 and an optional control device 115. Purely by way of example, the functional modules 110 in the embodiment represented are sensor modules which have each been set up to scan a sector of the ambient field of the vehicle 105. The scans can be processed further, for instance by a parking assistant, by an autonomous vehicle guidance system, or by an alarm system.

In order to construct the system 100 easily and cost-effectively, it is preferred that the functional modules 110 have been realized as like parts, so that any two functional modules 110 on the vehicle can be exchanged for one another without restricting the functionality of the system 100. At the same time, the functional modules 110 are also to have been individualized, so that each functional module 110 can perform its function in a manner depending on a position at which it has been attached to the vehicle 105. The functional module 110 is to be able to be supplied with electric current in various variants, so a chosen variant has been assigned to a position on the vehicle 105. The functional module 110 can preferably determine the chosen variant electrically and in this way can establish its position on the vehicle 100.

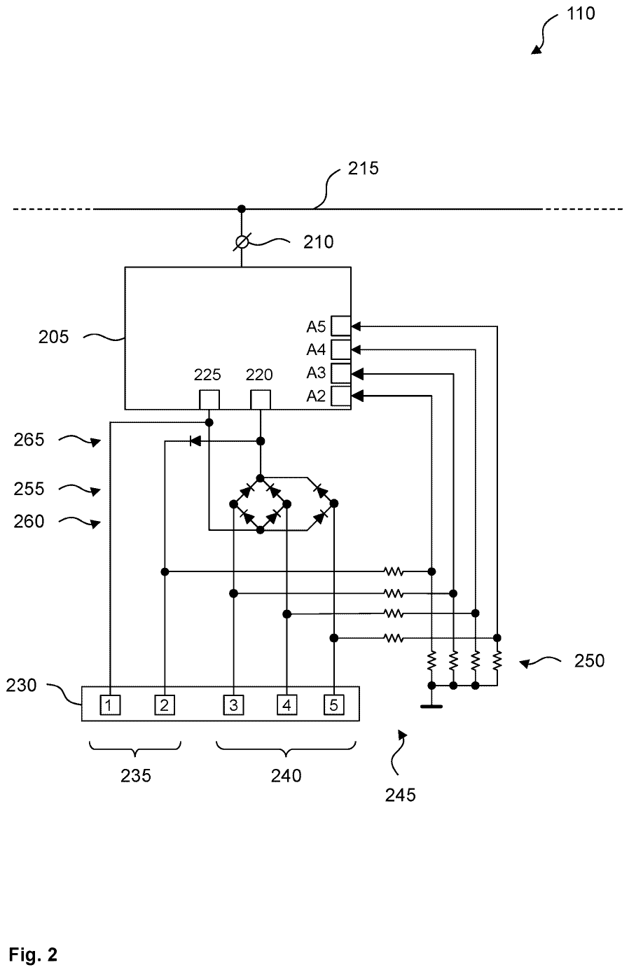

FIG. 2 shows a circuit diagram of a functional module 110 in a first exemplary embodiment. The functional module 110 includes a functional unit 205 which may comprise, in particular, a programmable microcomputer or microcontroller. The functional unit 205 may comprise a sensor, an actuator or a processing device, in order to perform a predetermined function on board the vehicle 100. The functional unit 205 can be connected to a communication bus 215 by means of an interface 210. For the purpose of supplying the functional unit 205 with electric current, a positive terminal 220 and a negative terminal 225 have been provided.

The functional module 110 includes several electrical terminals which may have been accommodated in a connector 230. The terminals in the connector 230 that are represented are labeled as pins 1 to 5. Pins 1 and 2 are encompassed by output terminals 235, while pins 3 to 5 are encompassed by supply terminals 240.

Furthermore, the functional unit 205 preferably includes analog and/or digital inputs for determining a level or a voltage. An analog input is labeled herein with an A, and a digital input is labeled with a D. A numeral immediately following indicates a pin in the connector 230 to which the input is connected. In the embodiment represented, four analog inputs A2 to A5 have been provided. Each input A2-A5 is connected to pin 2-5, assigned thereto, of the connector 230 by means of a series resistor 245. In addition, a pull-down resistor 250 connected to earth has been provided at each input A2-A5. Optionally, pull-up resistors may also have been provided (not shown).

The supply terminals 240 have been set up to be connected to an external voltage. Preferably only two of the existing supply terminals 240 have to be coupled. From each supply terminal 240, a first diode 255 extends in the forward direction to the positive terminal 220, and a second diode 260 extends in the blocking direction to the negative terminal 225. The diodes 255, 260 of each supply terminal 240 constitute a half-bridge. The half-bridges of two supply terminals 240 connected to the external voltage result in a full bridge, which is also called a bridge rectifier, so that, regardless of an assignment of pins 3-5 to potentials of the external voltage, current is routed to the terminals 220, 225 in the correct polarity in every case. In general, the external voltage includes a direct voltage and, more preferably, has a predetermined value.

By evaluating the analog inputs A3-A5, the functional unit 205 can determine the supply terminal 240 at which a high potential of the external voltage is applied, and the supply terminal 240 at which a low potential of the external voltage is applied. Optionally, the supply terminal 240 at which no potential of the external voltage is applied at all—or, to be more exact, the supply terminal 240 that is highly resistive—can also be determined. In the case of N supply terminals 240, generally N*(N−1) different possible assignments of potentials of the external voltage to two of the supply terminals 240 arise. In the embodiment shown, with three supply terminals 240, six different codings can accordingly already be undertaken solely with the aid of the connection of the external voltage.

The output terminals 235 have been set up to relay current to a further functional module 110. For this purpose, the positive terminal 220 is connected to pin 2 by means of a third diode 265, and the negative terminal 225 is directly connected to pin 1. Analog input A2 is connected to the cathode of the third diode 265.

If any two supply terminals 240 of a further functional module 110 are connected to the output terminals 235 of the functional module 110 represented, a current flows through the third diode 265. At the third diode 265 a predetermined threshold voltage of, for instance, approximately 0.5 V then drops, so that a voltage applied to pin 2 is lower by this amount than the operating voltage that is applied between terminals 220 and 225. If the operating voltage is not known, it can be determined by means of a further analog input (not shown).

However, if no load has been connected to the output terminals 235, a voltage at the third diode 265 does not drop. Ordinarily in this case, a voltage close to the supply voltage can be determined at A2. By sampling the voltage at A2, the functional component can determine whether a further functional component is drawing current via these supply terminals 240.

The functional component 110 can determine by means of daisy-chaining whether it is the last in a chain of functional components 110. The two functional modules 110 may accordingly differ from one another at least in that one of them determines that it is supplying yet another functional module 110, and the other is not. An already existing address space can be doubled in this way. For instance, with the embodiment that is represented a total of 12 functional modules 110 can be distinguished from one another, six of which have been coupled pairwise to the other six.

The following Table 1 shows possible assignments in respect of a functional module 110. For pins 3 to 5, “+” stands for a connection to a high potential, and “−” stands for a connection to a low potential of the external voltage. The numeric addresses have been chosen in exemplary manner. For analog inputs A4 to A5, “H” stands for a high potential, or a high voltage, “L” stands for a low potential, or a low voltage, and “O” stands for an open input that is not connected to another potential or is only connected with high resistance. For A2, “drop” stands for a voltage that arises when the predetermined drop in voltage occurs at the third diode 265 because a current is flowing through diode 265.

TABLE 1

| Pin 3 | Pin 4 | Pin 5 | Address | A2 | A3 | A4 | A5 |
|---|---|---|---|---|---|---|---|
| + | − | | 1 | | H | L | O |
| − | + | | 2 | | L | H | O |
| + | | − | 3 | | H | O | L |
| − | | + | 4 | | L | O | H |
| | − | + | 5 | | O | L | H |
| | + | − | 6 | | O | H | L |
| + | − | | 7 | drop | H | L | O |
| − | + | | 8 | drop | L | H | O |
| + | | − | 9 | drop | H | O | L |
| − | | + | 10 | drop | L | O | H |
| | − | + | 11 | drop | O | L | H |
| | + | − | 12 | drop | O | H | L |

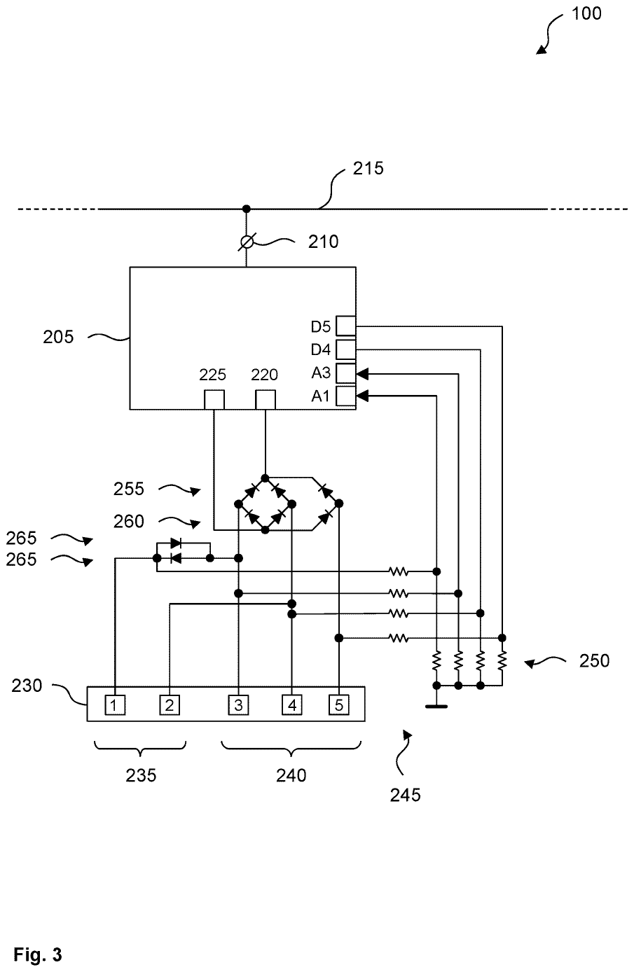

FIG. 3 shows a circuit diagram of a functional module 110 in a second embodiment. In contrast to the embodiment shown in FIG. 2, the output terminals 235 are connected not to the positive and negative terminals 220, 225 of the functional unit 205 but rather to pins 3 and 4 of the supply terminals 240. If daisy-chaining is to be used, the external voltage has to be connected to pins 3 and 4 of the functional module 110 represented; in this case, both polarities are possible. Levels at pins 4 and 5 can be determined here by means of digital inputs D4 and D5 instead of analog inputs A4 and A5.

With such functional modules 110, addresses 1 to 6 represented in Table 1 can substantially be represented with the aid of coding of the external voltage at the supply terminals 240. Additionally, addresses 7 and 8, at which the external voltage is applied to pins 3 and 4 and a further functional module 110 is connected to the output terminals 235, can be utilized.

It is to be noted that in this embodiment the voltage made available to the downstream functional module 110 at the output terminals 235 lies only one threshold voltage below the external voltage at the supply terminals 240, whereas in the embodiment shown in FIG. 2 this voltage may lie two threshold voltages below the external voltage. By virtue of the antiparallel two third diodes 265, both polarities of the external voltage at pins 3 and 4 can be exploited.

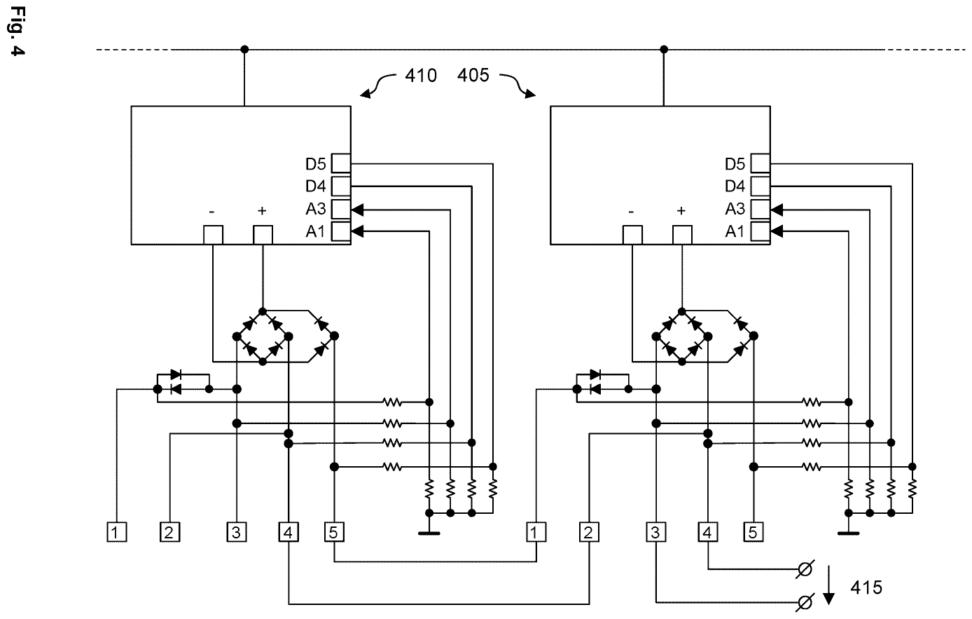

FIG. 4 shows a circuit diagram with two functional modules 110 connected to one another by means of daisy-chaining. On the right, a first functional module 405 and, on the left, a second functional module 410, each in an embodiment according to FIG. 3, are represented. Already elucidated designations of elements of the functional modules 405, 410 have been simplified or omitted in this Figure, in order to improve the overall view. Of particular interest here is the connection of the two functional modules 405, 410 to one another and to an external voltage 415.

Since the second functional module 410 is connected to the output terminals 235 of the first functional module 405, the drop in voltage at one of the third diodes 265 can be determined here. The linkage, chosen by way of example, of the external voltage 415 to pins 3 and 4, together with the specific drop in voltage according to Table 1, yields address 8 for the first functional module 405.

The second functional module 410 cannot determine a drop in voltage across its third diode 265. According to Table 1, it is therefore set to address 6 with the aid of the potentials at pins 4 and 5. It is to be noted that the address space from 1 to 6 is available here for the second functional module 410; on the other hand, only addresses 7 and 8 are available for the first functional module 410.

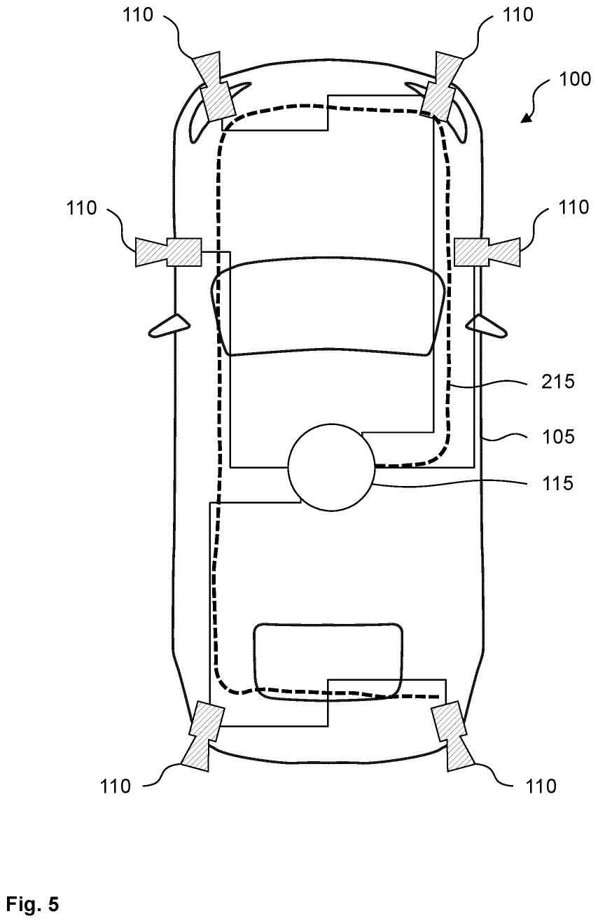

FIG. 5 shows a further system 105 in a vehicle 100. Proceeding from the system 105 shown in FIG. 1, four of the six functional modules 110 provided are directly connected to the control device 115; two further functional modules 110 are each coupled to one of the four. Shown in addition in stylized form is the communication bus 215 which connects together all the functional modules 110 and the control device 115 in a linear topology.

It can be seen how the cascading of the functional components 110 by means of daisy-chaining can contribute to laying lines of the communication bus 215 and lines to the control device 215 on similar paths. In the present case, all the lines can be routed through the vehicle 105 in only one bundle; only the two sections leading directly to the left from the control device 115 may require an additional connection. A line emanating from the control device 115 never supplies more than two functional components 110, so its cross-section can be kept small.

### REFERENCE SYMBOLS

100 vehicle
105 system
110 functional module
115 control device
205 functional unit
201 interface
215 communication bus
220 positive terminal
225 negative terminal
230 connector
235 output terminals
240 supply terminals
245 series resistor
250 pull-down resistor
255 first diode
260 second diode
265 third diode
A1-A5 analog input
D4-D5 digital input
405 first functional module
410 second functional module
415 external voltage

1-11. (canceled)

12. A functional module for a vehicle, the functional module comprising:
a positive terminal and a negative terminal configured to supply the functional unit with an operating voltage;
at least two supply terminals, wherein:
each supply terminal of the at least two supply terminals is connected to the positive terminal through a first diode, and connected to the negative terminal of the functional unit through a second diode;
forward directions of the first and second diodes each point from the negative terminal to the positive terminal; and
the functional unit is configured to determine the supply terminals between which an external voltage is applied; and
two output terminals configured to connect to supply terminals of another functional module of identical construction;
wherein the output terminals are configured to connected to the external voltage through a voltage-reducer; and
wherein the functional unit is configured to determine a drop in voltage across the voltage-reducer.

13. The functional module of claim 12, wherein the functional module is configured to carry out a predetermined task in a manner depending on a combination of supply terminals, between which the external voltage is applied, and a drop in voltage at the voltage-reducer.

14. The functional module of claim 12, wherein the functional module further comprises at least one of a sensor, an actuator or a processing device.

15. The functional module of claim 12, wherein the voltage-reducer comprises a diode in the forward direction.

16. The functional module of claim 12, wherein the functional module comprises an analog input which is connected to the output terminal that is connected to the voltage-reducer.

17. The functional module of claim 16, wherein the functional module comprises a further analog input which is connected to the terminal of the voltage-reducer that is not connected to the output terminal.

18. The functional module of claim 12, wherein the functional module comprises at least one digital input, in order to determine a level at one of the supply terminals.

19. The functional module of claim 12, further comprising an interface configured for a communication bus for communicating with an external location.

20. A system comprising a plurality of functional modules of claim 12, wherein for each functional module in the system, a combination of supply terminals, between which an external voltage is applied, and a drop in voltage at the voltage-reducer is unique.

21. A vehicle including at least one functional module according to claim 12.

22. A vehicle including a system according to claim 20.
